(19) United States
(12) Patent Application Publication
(10) Pub. No.: US 2005/0039203 A1
(43) Pub. Date: Feb. 17, 2005

(54) Disc for storing information

(76) Inventors: Chih-Hsuan Yang, Taipei City (TW); Chun-Wu Cheng, Taipei City (TW)

Correspondence Address: LOWE HAUPTMAN GILMAN & BERNER, LLP, Suite 310, 1700 Diagonal Road, Alexandria, VA, 22314, US

(21) Appl. No.: 10/640,325

(22) Filed: Aug. 14, 2003

(51) Int. Cl. G11B 3/70; G11B 5/84; G11B 7/26

(52) U.S. Cl. 720/721

(57) ABSTRACT

A disc for storing information is provided. The present disc includes a fixture and a storage element. The diameter of the present fixture is longer than that of the fixture of the prior art. The thickness of the fixture in the present invention is thicker than that of the fixture of the prior art.

### CROSS REFERENCE TO RELATED APPLICATION

This invention is related to the co-pending U.S. patent application entitled “DISC FOR STORING INFORMATION” assigned to the same assignee as the present application and incorporated herein by reference in its entirety.

### BACKGROUND OF THE INVENTION

1. Field of the Invention

The present invention relates to a disc for storing information, and more particularly, to a disc for storing information with a low oscillation.

2. Description of the Prior Art

The application of multimedia technology and computer hardware has improved as fast as the developments in science. The high speed oscillation of the disc has an unnoticeable problem, compared to a low speed rotation, when reading the information stored in the disc inside an optical apparatus, i.e. a video disc player or a CD-Writer. The unnoticeable problem, i. e. the oscillation of the disc, plays a decisive role in deciding the quality of the optical apparatus being worth or poor when the video disc player and the CD-Writer is improved to read the information stored in the disc at a high rotating speed.

The oscillation of the disc that rotates at high speed makes noise, which influences the operation of the reading system of the optical apparatus when the reading system reads the information in the disc. If the oscillation of the disc that rotates at high speed is too large, the hardware of the optical apparatus may be destroyed due to oscillation.

Some methods and some equipment designed for lowering the oscillation of the disc have been developed. For example, two applications, Taiwan Patent Publication No. 392146 and Taiwan Patent Publication No. 435785 disclose an oscillation absorbing method and oscillation absorbing equipment. Even if the methods and the equipment developed reduced the oscillation as the disc rotated at high speeds, some disadvantages of the methods and equipment, i.e. an extremely complex calculation, excess equipment, extremely difficult designs and an increased cost, all appear when trying to reduce the oscillation.

As shown in FIG. 1A, disc 1 of the prior art includes a hole 3, a fixture 5 and a storage element for storing information. The fixture 5 is fixed to rotate disc 1. As disc 1 rotates while a video disc player reads the information stored in the storage element 7. A sectional view of disc 1 along a cutting plane line X-X′ is shown in FIG. 1B. The thickness A of disc 1 being the public standard of 1.2 millimeters. The diameter C of the fixture 5 being public standard of 33 millimeters and the diameter of the whole disc 1 being 120 millimeters.

The method disclosed by Taiwan Patent Publication No. 392146 adjusts the rotational speed of disc 1 according to the signals received through a re-designed optical read and write head to lower the oscillation of disc 1 while the disc rotates.

An absorbing system disclosed by Taiwan Patent Publication No. 435785 placed inside an optical apparatus, i.e. a video disc player, a CD-Writer, a DVD-Player and a DVD-Writer, absorbs the oscillation of disc 1 when the information stored in the storage element 7 is read or erased. The disclosed system absorbs the oscillation of disc 1 and increases the weight of the whole optical apparatus because the weight of the disclosed system is approximately one-third the weight of the optical apparatus. The increased weight due to the absorbing system makes the optical apparatus being inconvenient to be used. Moreover, the increased-weight of the optical apparatus may cause unexpected shocks by an external hit because the increased weight enhances the effect and increases the displacement of the disc. So, the absorption system with the increased weight is unable to absorb the oscillation of a disc while rotating at high speeds inside a moving optical apparatus.

The absorb-oscillation structure and the absorb-principle of the absorption systems of the prior art are always complex. Optical apparatus including the absorption system of the prior art is always more expensive. The prior method or the prior system reduces the oscillation of the disc and increases the disadvantages of the optical apparatus at the same time.

According to the above description, it is necessary to develop an element to reduce the oscillation of a disc that rotates at high speed.

### SUMMARY OF THE INVENTION

According to the above description of the background of the invention, it is one objective of the present invention to provide a structure of a disc to reduce the oscillation of the disc that rotates at high speed without unnecessary absorbing-oscillation equipment, complex calculation and complex design.

It is an another objective of the present invention to provide a structure of a disc to lower the oscillation of a disc by reducing the effective length of a storage element of the disc.

It is a further objective of the present invention to provide a structure of a disc to reduce the oscillation of the disc by increasing the natural frequency of the disc when the disc rotates at high speed.

It is a further objective of the present invention to provide a structure of a disc to lower the oscillation of the disc that rotates at high speeds and to increase the storage capacity for storing information at the same time.

It is a further objective of the present invention to provide a structure of a disc to lower the oscillation of the disc that rotates at high speeds and to prevent the disc from being broken at the same time.

The present invention provides a structure of a disc for storing information that includes a fixture having a longer diameter or a thicker thickness to lower the oscillation of the disc that rotates at high speeds. When a video disc player reads a disc or a CD-Writer writes a disc, the video disc player or the CD-Writer fixes the fixture to rotate the disc. The disc increases the storage capacity and the folding endurance at the same time.

All these advantageous features as well as others that are obvious from the following detailed description of the preferred embodiments of the invention are obtained.

### BRIEF DESCRIPTION OF THE DRAWINGS

FIG. 1A is a top view of a disc of the prior art;

FIG. 1B is a sectional view of a disc of the prior art;

FIG. 2A is a top view of a disc of the present art;

FIG. 2B is a sectional view of the first embodiment of the present invention;

FIG. 2C is a sectional view of the second embodiment of the present invention;

FIG. 2D is a sectional view of the third embodiment of the present invention;

FIG. 2E is a sectional view of the fourth embodiment of the present invention; and

FIG. 2F is a sectional view of the fifth embodiment of the present invention.

### DESCRIPTION OF THE PREFERRED EMBODIMENT

In the present disclosure, the words “a” or “an” are to be taken to include both the singular and the plural. Conversely, any reference to plural items shall, where appropriate, include the singular.

The preferred embodiments of the present invention provide a disc for storing information to improve the disadvantages of the prior art. Nonetheless, it should be recognized that the present invention can be practiced in a wide range of other embodiments besides those explicitly described, and the scope of the present invention is expressly not limited except as specified in the accompanying claims.

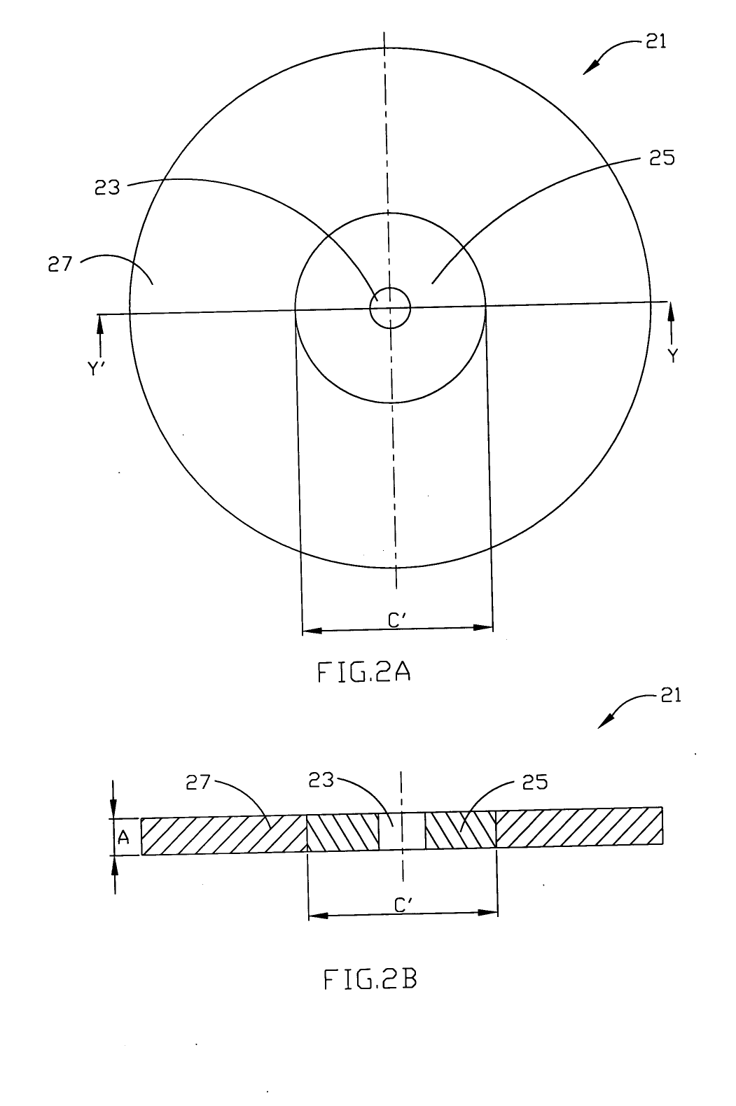

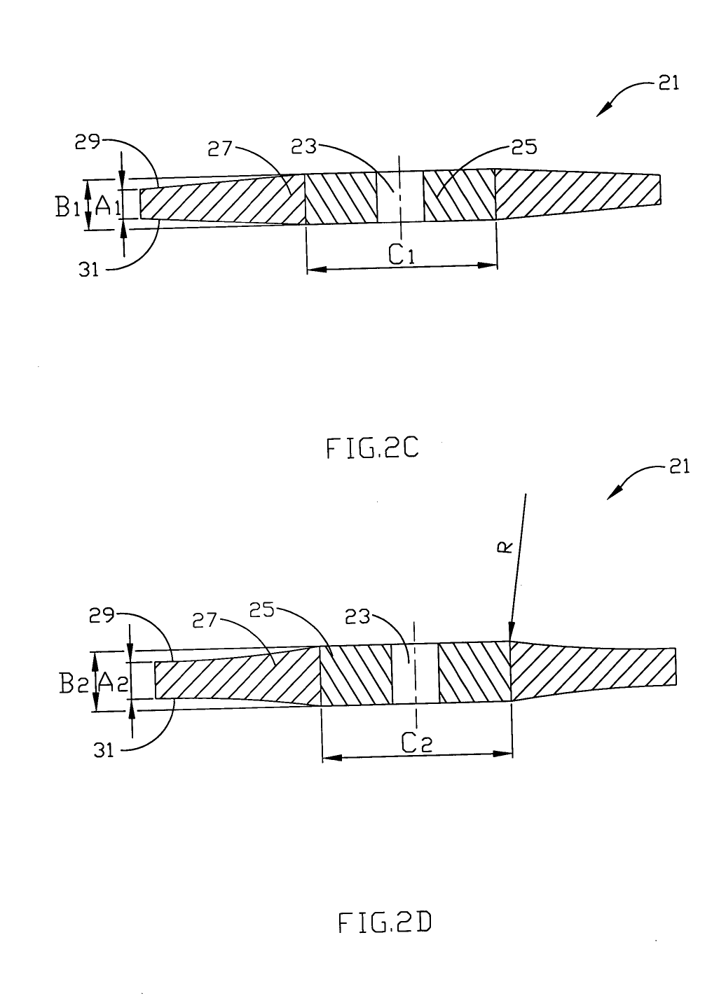

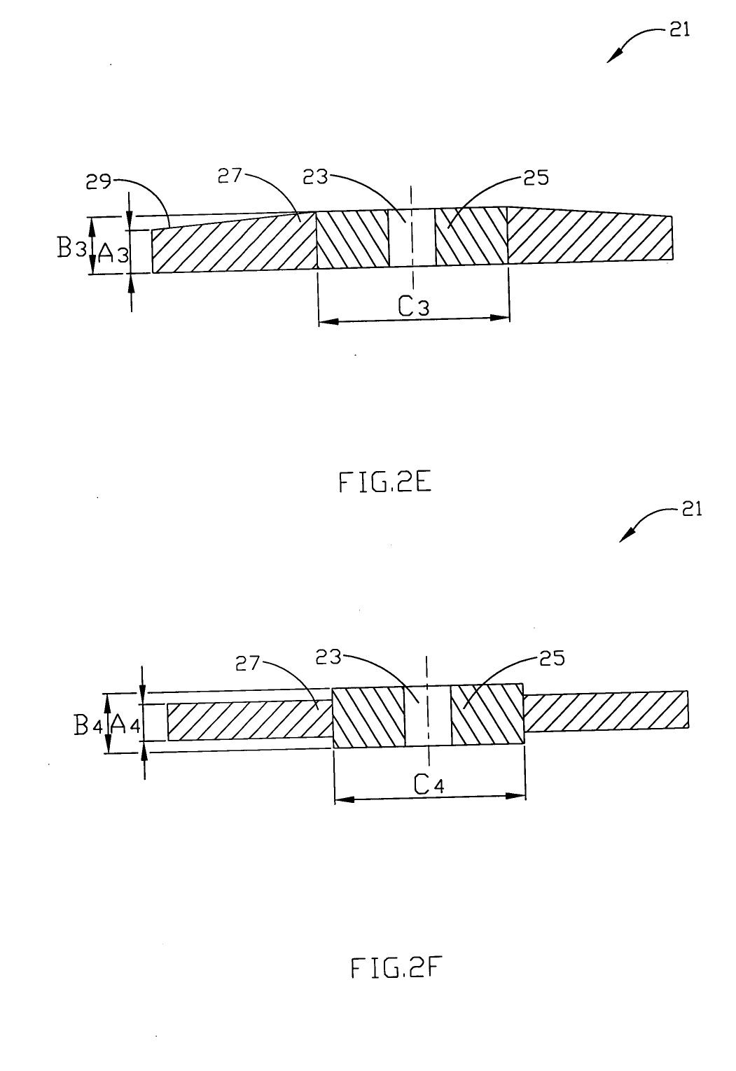

As shown in FIG. 2A, a disc for storing information 21 includes a fixture 25 that is a circular plane with a hole 23, and a storage element 27 being extended from the fixture 25. A surface for the storage element 27 stores information.

According to the FIG. 2B, is a sectional view of disc 21 along a cutting plane line Y-Y′, the thickness of the disc is A. The diameter of the fixture 25 is C′. The diameter C′ of the fixture 25 is longer than 33 millimeters that the diameter C of the prior fixture 3 approximately is to reduce the oscillation when disc 21 rotates at high speeds.

When the displacement of the oscillation of disc 21 reduces, the oscillation of disc 21 is reduced. When increasing the diameter C of the fixture 27, the effective length for the storage element 27 is reduced. The displacement of the oscillation of disc 21 reduces in response to cubing the reduction of the effective length of the storage element 27. Disc 21 of the present invention includes a longer diameter C′ of the fixture 25 to reduce the oscillation when disc 21 rotates at high speeds. If the diameter C′ of the fixture 25 is 43 millimeter (mm), that is longer than the diameter C of the fixture 5 of disc 1 of the prior art. The displacement of the oscillation of disc 21 is reduced by half the displacement of the oscillation. Of course, the diameter C′ of the fixture 25 also could increase more or less according to some other reasons, too.

The sectional view of a disc 21 of the second embodiment of the present invention is shown in FIG. 2C. Except the diameter C₁ of the fixture 25 is longer than that of diameter C of disc 1 of the prior art, the storage element 27 includes a top slant surface 29 and a bottom slant surface 31. As shown in FIG. 2C, the thickness of the storage element 27 is reduced when the distance between the storage element 27 and the fixture 27 increases. A longer distance between a point for the storage element 27 and the fixture 25, the thinner thickness of the point of the storage element 27.

The displacement of the oscillation of the disc has an inverse ratio of the square of the natural frequency of the disc. For example, the displacement of the oscillation of the disc is reduced by four times when the natural frequency is doubled. If the natural frequency of the disc is increased to 150%, the oscillation of the disc is reduced by half of the oscillation of the disc.

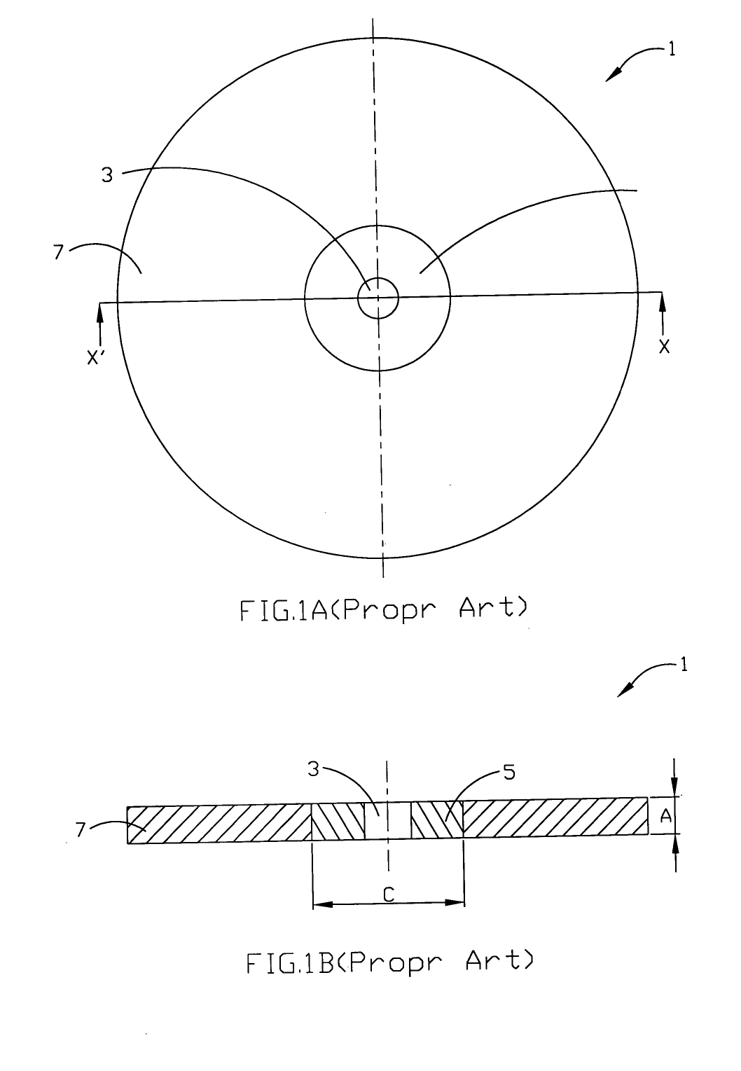

As shown in FIG. 2C, the diameter C₁ of the fixture 25, i.e. 43 mm is longer than that of the prior fixture 5. The thickness B₁ of the fixture 25 is thicker than the thickness A of the prior fixture 5, i.e. 1.2 mm, while the thickness A₁ of the edge of the storage element 27 and the thickness A of the prior storage element 7 of FIG. 1B are the same. During reading or writing, the natural frequency of the prior disc 1 is approximately 70 Hz. The natural frequency of the present disc 21 is approximately 96 Hz. Therefore the displacement of the oscillation of the present disc 21 is approximately half of that of the prior disc 1. If the thickness of the fixture 5 is increased to 4 mm, disc 21 being rotated at high speed is more stable with low oscillation. In other words, the thickness of the fixture 25 is thicker than that of the thickest part of the storage element 27 and is thinner than 4 millimeters to reduce the oscillation itself.

Besides the longer diameter C₁ and the thicker thickness B₁ of the fixture 27, the storage element 27 further includes a top slant surface 29 and a bottom slant surface 31. Because the angles of inclination of the top slant surface 29 and the bottom slant surface 31 are constant values, the sectional views of the top slant surface 29 and the bottom slant surface 31 are straight.

As shown in FIG. 2D, disc 21 includes a fixture 25 with a longer diameter C₂ and a thicker thickness B₂, and a storage element 27 with a top slant surface 29 and the bottom slant surface 31. The thickness B₂ of the fixture 25 is thicker than the thickness of the edge of the storage element 27. However, the top slant surface 29 and the bottom slant surface 31 are curved surfaces with a radius R of curvature. The angles of inclination of the top slant surface 29 and the bottom slant surface 31 are smaller than 2°. Furthermore, as shown in FIG. 2E, the disc of the fourth embodiment of the present invention could steadily rotate with a lower oscillation and at higher speeds. Disc 21 includes a fixture 25 that includes a longer diameter C₃ and a thicker thickness B₃ that is thicker than the thickness A₃ of the edge of the storage element 27 to rotate at higher speeds with a lower oscillation. Even if the storage element 27 has only one slant surface such as the top slant surface 29, the oscillation of disc 21 still can reduce.

As shown in FIG. 2F, the fixture 25 includes a longer diameter C₄. The storage element 27 does not include the top slant surface 29 or the bottom slant surface 31. The thickness A₄ of the storage element 27 is uniform. The thickness B₄ of the fixture 25 is thicker than the thickness A₄ of the storage element 27 to reduce the oscillation of disc 21 when disc 21 rotates at high speeds.

Furthermore, even if the thickness, that is thicker than 1.2 millimeter, of a fixture 25 with a longer diameter C′ and the thickness of a storage element 27 are the same, the oscillation of disc 21 rotated at high speeds still can reduce.

In these embodiments of the present invention, the thickness of the fixture 27 thinner than four millimeters subjects to the present reading or writing ability of the optical apparatus, i.e. video disc player, Compact Disc player, CD-Writer, CD-ReWriter, DVD-player, DVD-Writer, and DVD-ReWriter and so on. If the reading ability of these optical machines is improved in the future, the limitation on the thickness of the fixture 25 and the angle of inclination of the slant surfaces of the storage element 27 will be reduced or disappear. Of course, some capabilities that are achieved due to the structure of the disc of the present invention should be within the scope of the present claims.

The present invention provides a structure of a disc to reduce the oscillation of the disc that rotates at high speeds without increasing the amount of unnecessary elements. The present invention also provides a structure of a disc to directly reduce the oscillation of the disc without the optical signal-adjustment technology or lowering the rotating speed of the disc. The structure of the disc of the present invention lowers the oscillation when the disc rotates at high speeds and avoids the disadvantages of the prior art such as cost and extra weight from the unnecessary elements.

The storage capacity of the disc 25 increases with the top slant surface 29 and the bottom slant surface 31 of the storage element 27. The folding endurance of the disc of the present invention increases to prevent the improperly external force due to the thicker thickness B of the fixture 25. In the other words, the disc of the present invention lowers the oscillation of the disc as well as prevents the risk of losing data resulting from lowing the danger of losing data due to a broken disc.

The above description only demonstrates and illustrates the preferred embodiments of the present invention, but does not limit the scope of the present invention to what described detailed herein; and any equivalent variations and modifications of the present invention should be within the scope of the claims hereafter.

1. A disc for storing information, comprising:
a fixture being a circular plane with a hole, and the diameter of said fixture being longer than 33 millimeters; and
a storage element being extended from said fixture, wherein a surface of said storage element stores information.

2. The disc for storing information according to claim 1, wherein said diameter of said fixture is 43 millimeters.

3. The disc for storing information according to claim 1, wherein the thickness of said fixture is 2 millimeters.

4. The disc for storing information according to claim 1, wherein said storage element includes a top slant surface.

5. The disc for storing information according to claim 4, wherein the thickness of said storage element reduces when the distance between said storage element and said fixture increases.

6. The disc for storing information according to claim 4, wherein the angle of inclination of said top slant surface is a constant value.

7. The disc for storing information according to claim 4, wherein said top slant surface is a curved surface.

8. The disc for storing information according to claim 4, wherein the angle of inclination of said top slant surface is smaller than 2°.

9. The disc for storing information according to claim 4, wherein said storage element further includes a bottom slant surface.

10. The disc for storing information according to claim 9, wherein the angle of inclination of said bottom slant surface is a constant value.

11. The disc for storing information according to claim 9, wherein said bottom slant surface is a curved surface.

12. The disc for storing information according to claim 9, wherein the angle of inclination of said bottom slant surface is smaller than 2°.

13. The disc for storing information according to claim 1, wherein the thickness of said fixture is thicker than that of the thickest part of said storage element.

14. The disc for storing information according to claim 13, wherein the thickness of said thickest part of said storage element is 1.2 millimeters.

15. The disc for storing information according to claim 13, wherein the thickness of said fixture is thicker than that of the thickest part of said storage element and is thinner than 4 millimeters.

16. A disc for storing information, comprising:
a fixture being a circular plane with a hole, wherein the diameter of said fixture is longer than 33 millimeters and the thickness of said fixture is thicker than 1.2 millimeters ; and
a storage element being extended from said fixture, wherein a surface of said storage element stores information.
